(19) United States
(12) Patent Application Publication
(10) Pub. No.: US 2008/0244221 A1
(43) Pub. Date: Oct. 2, 2008

(54) EXPOSING SYSTEM TOPOLOGY TO THE EXECUTION ENVIRONMENT

(76) Inventors: Donald K. Newell, Portland, OR (US); Jaideep Moses, Portland, OR (US); Ravishankar Iyer, Portland, OR (US); Rameshkumar G. Illikkal, Portland, OR (US); Srihari Makineni, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/694,322

(22) Filed: Mar. 30, 2007

(51) Int. Cl. G06F 15/00

(52) U.S. Cl. 712/11

(57) ABSTRACT

Embodiments of apparatuses, methods, and systems for exposing system topology to an execution environment are disclosed. In one embodiment, an apparatus includes execution cores and resources on a single integrated circuit, and topology logic. The topology logic is to populate a data structure with information regarding a relationship between the execution cores and the resources.

### BACKGROUND

1. Field

The present disclosure pertains to the field of information processing, and more particularly, to the field of optimizing the performance of multi-processor systems.

2. Description of Related Art

One or more multi core processors may he used in a multi-processor system on which an operating system (“OS”), virtual machine monitor (“VMM”), or other scheduling software schedules processes for execution. Generally, a multi core processor is a single integrated circuit including more than one execution core. An execution core includes logic for executing instructions. In addition to the execution cores, a multi core processor may include any combination of dedicated or shared resources. A dedicated resource may be a resource dedicated to a single core, such as a dedicated level one cache, or may be a resource dedicated to any subset of the cores. A shared resource may be a resource shared by all of the cores, such as a shared level two cache or a shared external bus unit supporting an interface between the multicore processor and another component, or may be a resource shared by any subset of the cores.

### BRIEF DESCRIPTION OF THE FIGURES

The present invention is illustrated by way of example and not limitation in the accompanying figures.

FIG. 1 illustrates an embodiment of the present invention a multi-processor system.

FIG. 2 illustrates an embodiment of the present invention in a multicore processor.

FIG. 3 illustrates an embodiment of the present invention in a method for scheduling processes to run on a multi-processor system.

### DETAILED DESCRIPTION

Embodiments of apparatuses, methods, and systems for exposing system topology to the execution environment are described below. In this description, numerous specific details, such as component and system configurations, may be set forth in order to provide a more thorough understanding of the present invention. It will be appreciated, however, by one skilled in the art, that the invention may be practiced without such specific details. Additionally, some well known structures, circuits, and the like have not been shown in detail, to avoid unnecessarily obscuring the present invention.

The performance of a multi-processor system may depend on the interaction between the system topology and the execution environment. For example, the degree to which processes that share data are scheduled to run on execution cores that share a cache may affect performance. Other aspects of system topology, such as the relative latencies for different cores to access different caches, may also cause performance to vary based on scheduling or other execution environment level decisions. Embodiments of the present invention may be used to expose the overall system topology to the execution environment, which may include an operating system, virtual machine monitor, or other program that schedules processes to run on the system. The topology information may then be used by the execution environment to improve performance.

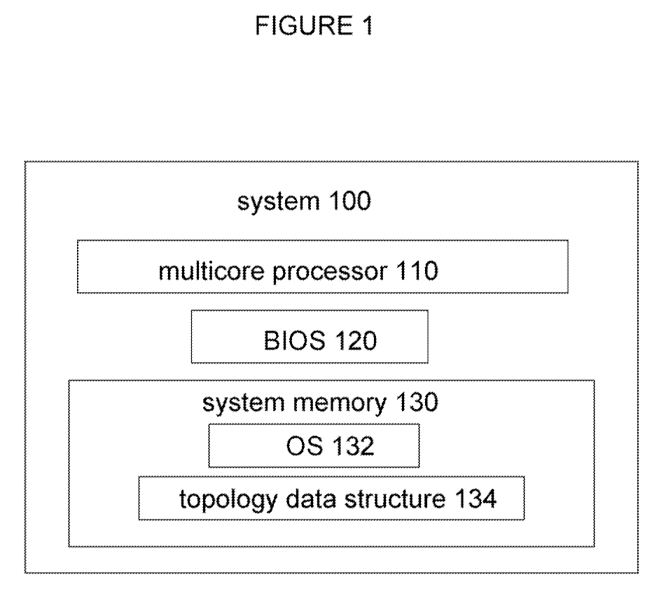

FIG. 1 illustrates an embodiment of the present invention in multi-processor system 100. System 100 may be any information processing apparatus capable of executing any OS or VMM. For example, system 100 may be a personal computer, mainframe computer, portable computer, handheld device, set-top box, server, or any other computing system. System 100 includes multicore processor 110, basic input/output system (“BIOS”) 120, and system memory 130.

Multicore processor 110 may be any component having one or more execution cores, where each execution core may be based on any of a variety of different types of processors, including a general purpose microprocessor, such as a processor in the Intel® Pentium® Processor Family, Itanium® Processor Family, or other processor family from Intel® Corporation, or another processor from another company, or a digital signal processor or microcontroller, or may be a reconfigurable core (e.g. a field programmable gate array). Although FIG. 1 shows only one multicore processor, system 100 may include any number of processors, including any number of single core processors, any number of multicore processors, each with any number of execution cores, and any number of multithreaded processors or cores, each with any number of hardware threads.

BIOS 120 may be any component storing instructions to initialize system 100. For example, BIOS 120 may be firmware stored in semiconductor-based read-only or flash memory. System memory 130 may be static or dynamic random access memory, semiconductor-based read-only or flash memory, magnetic or optical disk memory, any other type of medium readable by processor 110, or any combination of such mediums.

Processor 110, BIOS 120, and system memory 130 may be coupled to or communicate with each other according to any known approach, such as directly or indirectly through one or more buses, point-to-point, or other wired or wireless connections. System 100 may also include any number of additional devices or connections.

FIG. 1 also shows OS 132 and topology data structure 134 stored in system memory 130. OS 132 represents any OS, VMM, or other software or firmware that schedules processes to run on system 100. Topology data structure 134 represents any table, matrix, or other data structure or combination of data structures to store system topology information.

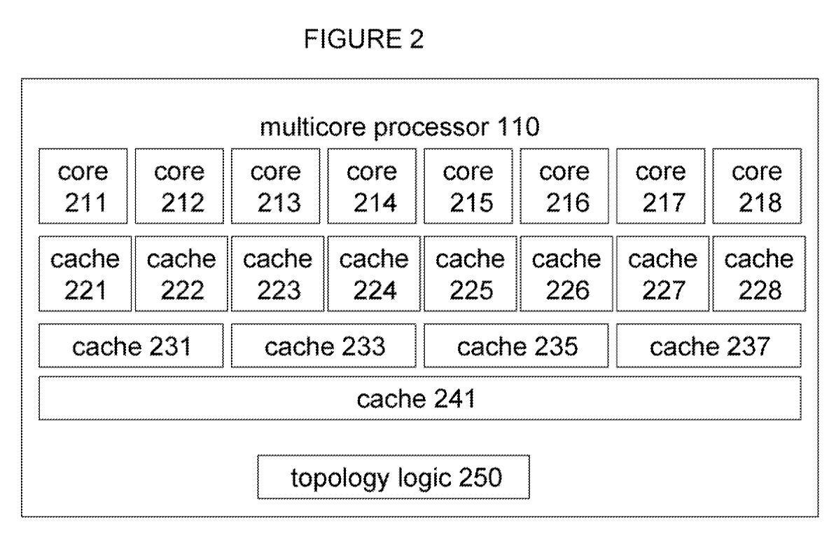

FIG. 2 illustrates multi core processor 110, according to one embodiment of the present invention. Multicore processor 110 includes cores 211, 212, 213, 214, 215, 216, 217, and 218, first level caches 221, 222, 223, 224, 225, 226, 227, and 228, mid level caches 231, 233, 235, and 237, and last level cache 241. In addition, multicore processor 110 includes topology logic 250. Each core may support the execution of one or more hardware threads.

In this embodiment, first level caches 221, 222, 223, 224, 225, 226, 227, and 228 are private caches, dedicated to cores 211, 222, 223, 224, 225, 226, 227, and 228, respectively. Mid level caches 231, 233, 235, and 237 are shared, with cores 211 and 212 sharing cache 231, cores 213 and 214 sharing cache 233, cores 215 and 216 sharing cache 235, and cores 217 and 218 sharing cache 237. Last level cache 241 is shared by all eight cores. In other embodiments, multicore processor 110 may include any number of cores, any number of caches, and/or any number of other dedicated or shared resources, where the cores and resources may be arranged in any possible system topology, such as a ring or a mesh topology.

Topology logic 250 may be any circuitry, structure, or logic to populate topology data structure 134 with information regarding the topology of processor 110. The information may include any information regarding any relationship between one or more of the cores or threads and one or more of the resources. In one embodiment, the information may include the relative or absolute latency for each core or thread to access each cache, expressed, for example, as clock cycles in an unloaded system. The information may be found, estimated, or predicted using any known approach, such as based on the proximity of a core to a cache. In another embodiment, the information may include a listing of which cores share which caches.

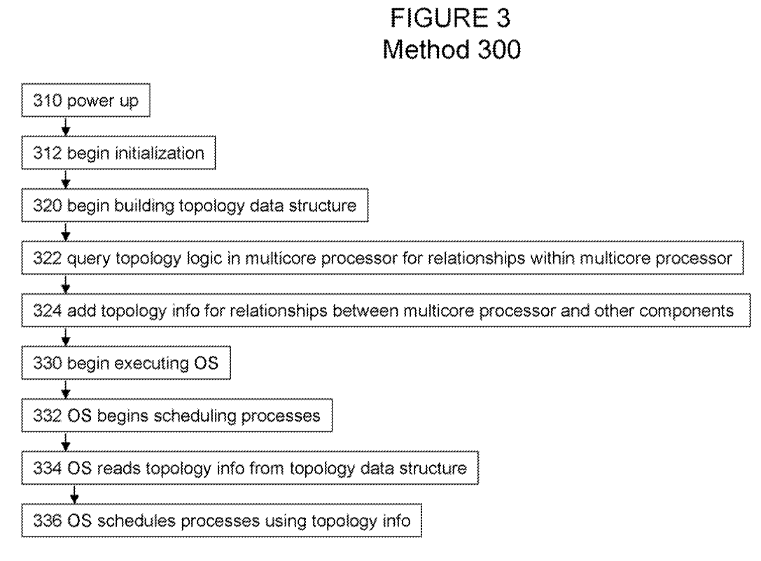

FIG. 3 illustrates an embodiment of the present invention in method 300, a method for scheduling processes to run on a multi-processor system. Although method embodiments are not limited in this respect, reference is made to the description of system 100 of FIG. 1 to describe the method embodiment of FIG. 3.

In box 310 of FIG. 3, system 100 is powered up or reset. In box 312, BIOS 120 begins to initialize system 100.

In box 320, BIOS 120 begins to build topology data structure 134. In box 322, BIOS 120 queries processor 110 for topology information to populate topology data structure 134. For example, box 322 may include adding the latencies for cores in processor 110 to access caches in processor 110.

In box 324, BIOS generates or gathers information regarding relationships between processor 110 and other processors or components in system 100. For example, in one embodiment, four processors may be connected through a point-to-point interconnect fabric, such that cores in one processor may use caches in another processor. In this embodiment, box 324 may include adding the latencies for cores in processor 110 to access caches outside of processor 110.

Boxes 320, 322, and 324 may be performed in connection with the building of a system resource affinity table, or any other table or data structure according to the Advanced Configuration and Power Interface specification, revision 3.0b, published Oct. 10, 2006, or any other such protocol. Method 300 may also include querying any other processors or components for topology information to populate topology data structure 134 or any other such data structure,

In box 330, system 100 begins to execute OS 132, In box 332, OS 132 begins to schedule processes to run on system 100. In box 334, OS 132 reads system topology information from topology data structure 134. In box 336, OS 132 uses the system topology information to schedule processes to run on system 100.

OS 132 may use the system topology information to schedule processes to run so as to provide for better system performance than may be possible without the system topology information. For example, OS 132 may use the information that two cores share a mid level cache to schedule two processes that are known or predicted to have a high level of data sharing on these two cores, rather than on two cores that use two different mid level caches. Therefore, overall system performance may improve due to higher cache hit rates and lower cache snoop traffic.

Within the scope of the present invention, method 300 may be performed in a different order, with illustrated boxes omitted, with additional boxes added, or with a combination of reordered, omitted, or additional boxes.

Processor 110, or any other component or portion of a component designed according to an embodiment of the present invention, may be designed in various stages. from creation to simulation to fabrication. Data representing a design may represent the design in a number of manners. First, as is useful in simulations, the hardware may be represented using a hardware description language or another functional description language. Additionally or alternatively, a circuit level model with logic and/or transistor gates may be produced at some stages of the design process. Furthermore, most designs, at some stage, reach a level where they may be modeled with data representing the physical placement of various devices. In the case where conventional semiconductor fabrication techniques are used, the data representing the device placement model may be the data specifying the presence or absence of various features on different mask layers for masks used to produce an integrated circuit.

In any representation of the design, the data may be stored in any form of a machine-readable medium. An optical or electrical wave modulated or otherwise generated to transmit such information, a memory, or a magnetic or optical storage medium, such as a disc, may be the machine-readable medium. Any of these media may “carry” or “indicate” the design, or other information used in an embodiment of the present invention. When an electrical carrier wave indicating or carrying the information is transmitted, to the extent that copying, buffering, or re-transmission of the electrical signal is performed, a new copy is made. Thus, the actions of a communication provider or a network provider may constitute the making of copies of an article, e.g., a carrier wave, embodying techniques of the present invention.

Thus, apparatuses, methods, and systems for exposing system topology to the execution environment have been disclosed. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. An apparatus comprising;
a plurality of execution cores on a single integrated circuit;
a plurality of resources on the single integrated circuit; and
topology logic to populate a data structure with information regarding at least one relationship between at least one of the plurality of execution cores and at least one of the resources.

2. The apparatus of claim 1, wherein the plurality of resources includes cache memories.

3. The apparatus of claim 1, wherein at least one of the resources is shared by at least two of the plurality of execution cores.

4. The apparatus of claim 1, wherein at least one of the plurality of execution cores includes at least two hardware threads.

5. The apparatus of claim 1, wherein the topology logic is to populate the data structure with information regarding the latency associated with each execution core accessing each resource.

6. The apparatus of claim 4, wherein the topology logic is to populate the data structure with information regarding the latency associated with each hardware thread accessing each resource.

7. The apparatus of claim 3, wherein the topology logic is to populate the data structure with information regarding the sharing of resources.

8. The apparatus of claim 1, wherein at least one of the execution cores is to execute scheduling software to schedule processes to run on the plurality of execution cores.

9. The apparatus of claim 8, wherein the scheduling software is to schedule the processes based on information stored in the data structure.

10. A method comprising:
storing information regarding relationships among a plurality of execution cores and a plurality of resources on a single integrated circuit; and
using the information to schedule processes to am on the plurality of execution cores.

11. The method of claim 10, wherein the plurality of resources includes cache memories.

12. The method of claim 10, wherein storing information includes storing information regarding the latency associated with each execution core accessing each resource.

13. The method of claim 10, wherein storing information includes storing information regarding the sharing of the resources by the execution cores.

14. A system comprising:
a multicore processor including:
a plurality of execution cores;
a plurality of resources; and
topology logic to populate a data structure with information regarding at least one relationship between at least one of the plurality of execution cores and at least one of the resources; and
a memory to store the data structure.

15. The system of claim 14, further comprising firmware to be executed by one of the plurality of execution cores to build the data structure.

16. The system of claim 14, wherein the memory is also to store a scheduling program to schedule processes to be executed by the system.

17. The system of claim 14, wherein the scheduling program is to read information from the data structure to use in scheduling processing to be executed by the system.

18. The system of claim 14, wherein the plurality of resources includes cache memories.

19. The system of claim 14, wherein the topology logic is to store information regarding the latency associated with each execution core accessing each resource.

20. The system of claim 14, wherein the topology logic is to store information regarding the sharing of the resources by the execution cores.
